(19) United States
(12) Patent Application Publication
(10) Pub. No.: US 2021/0103855 A1
(43) Pub. Date: Apr. 8, 2021

(54) AUTOMATED MODEL TRAINING DEVICE AND AUTOMATED MODEL TRAINING METHOD FOR SPECTROMETER

(71) Applicant: Coretronic Corporation, Hsin-Chu (TW)

(72) Inventors: Feng Wang, Hsin-Chu (TW); Yen-Chun Huang, Hsin-Chu (TW)

(73) Assignee: Coretronic Corporation, Hsin-Chu (TW)

(21) Appl. No.: 17/037,557

(22) Filed: Sep. 29, 2020

(30) Foreign Application Priority Data
Oct. 8, 2019 (CN) 201910949149.7

(51) Int. Cl. G06N 20/00; G06N 7/00; G06K 9/62; G06F 7/24; G01N 21/25

(52) U.S. Cl. CPC G06N 20/00; G06N 7/005; G01N 21/25; G06F 7/24; G06K 9/6227

(57) ABSTRACT

The disclosure provides an automated model training method for a spectrometer, wherein the model training method is executed by a processor, and the model training method includes: obtaining spectral data; selecting at least one preprocessing model from one or a plurality of preprocessing models; selecting a first machine learning model from one or a plurality of machine learning models; establishing a pipeline corresponding to the at least one preprocessing model and the first machine learning model; and training an identification model corresponding to the pipeline according to the spectral data and the pipeline. The disclosure further provides a model training device and a spectrometer.

### CROSS-REFERENCE TO RELATED APPLICATION

This application claims the priority benefit of China application serial no. 201910949149.7, filed on Oct. 8, 2019. The entirety of the above-mentioned patent application is hereby incorporated by reference herein and made a part of this specification.

### BACKGROUND

### Technical Field

The disclosure relates to the technology of a spectrometer, and more particularly to an automated model training device and automated model training method for a spectrometer and to a spectrometer.

### Description of Related Art

An application of a spectrometer relies on how good the identification model used to detect spectral features is, and different applications correspond to different spectral features. Therefore, each application of the spectrometer requires an expert to establish a corresponding identification model. The expert has to repeatedly try combinations of multiple preprocessing models, a machine learning model, and a hyperparameter to generate a suitable identification model, and the generated identification model is not necessarily optimal.

Further, there are often differences among multiple spectrometers, and when spectral measurements are performed, the measurement results are likely to be influenced by the optical path of the scattered light. Therefore, the same identification model is usually not used in different spectrometers, and the user needs to separately train or correct identification models for different spectrometers. Therefore, manufacturers are not only unable to mass-produce spectrometers but also have to spend a considerable amount of money to maintain numerous identification models.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

In view of this, the disclosure provides an automated model training device and automated model training method for a spectrometer and a spectrometer, which can quickly establish an optimal identification model and allow the identification model to be used in different spectrometers.

Other objects and advantages of the disclosure may be further understood from the technical features disclosed herein.

In order to achieve one or a part or all of the above or other objects, the disclosure provides an automated model training method for a spectrometer, wherein the automated model training method is executed by a processor, and the automated model training method includes: obtaining spectral data; selecting at least one preprocessing model from one or a plurality of preprocessing models; selecting a first machine learning model from one or a plurality of machine learning models; establishing a pipeline corresponding to the at least one preprocessing model and the first machine learning model; and training an identification model corresponding to the pipeline according to the spectral data and the pipeline, wherein a hyperparameter of the pipeline is optimized according to the spectral data to train the identification model.

In order to achieve one or a part or all of the above or other objects, the disclosure provides a spectrometer including an identification model generated by the above automated model training method.

In order to achieve one or a part or all of the above or other objects, the disclosure provides an automated model training device for a spectrometer, and the automated model training device includes a transceiver, a processor, and a storage medium. The transceiver obtains spectral data. The storage medium stores a plurality of modules. The processor is coupled to the transceiver and the storage medium, and accesses and executes the plurality of modules, wherein the plurality of modules include a preprocessing module, a machine learning module, and a training module. The preprocessing module stores one or a plurality of preprocessing models. The machine learning module stores one or a plurality of machine learning models. The training module selects at least one preprocessing model from the one or the plurality of preprocessing models, selects a first machine learning model from the one or the plurality of machine learning models, establishes a pipeline corresponding to the at least one preprocessing model and the first machine learning model, and trains an identification model corresponding to the pipeline according to the spectral data and the pipeline, wherein the training module optimizes a hyperparameter of the pipeline according to the spectral data to train the identification model.

In order to achieve one or a part or all of the above or other objects, the disclosure provides a spectrometer including an identification model generated by the above automated model training device.

Based on the above, the automated model training device and the automated model training method of the disclosure can efficiently generate an identification model for detecting the spectral data.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of an automated model training device for a spectrometer according to an embodiment of the disclosure.

FIG. 2 is a schematic diagram of training an identification model using the automated model training device according to an embodiment of the disclosure.

FIG. 3 is a flow chart of an automated model training method for a spectrometer according to an embodiment of the disclosure.

### DESCRIPTION OF THE EMBODIMENTS

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

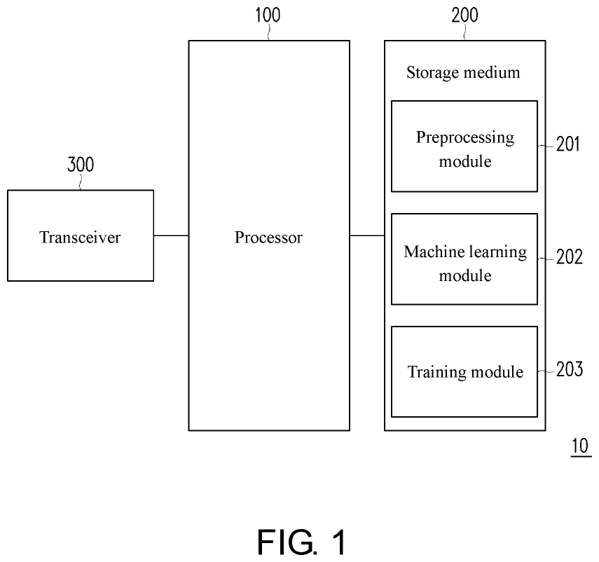

FIG. 1 is a schematic diagram of an automated model training device 10 for a spectrometer according to an embodiment of the disclosure. The automated model training device 10 is configured to automatically select an optimal combination for specific spectral features from combinations of various preprocessing algorithms, machine learning algorithms, and hyperparameters to generate an identification model for detecting the specific spectral features. The automated model training device 10 includes a processor 100, a storage medium 200, and a transceiver 300.

The processor 100 is, for example, a central processing unit (CPU), or other programmable general purpose or special purpose micro control unit (MCU), a microprocessor, a digital signal processor (DSP), a programmable controller, an application specific integrated circuit (ASIC), a graphics processing unit (GPU), an arithmetic logic unit (ALU), a complex programmable logic device (CPLD), a field programmable gate array (FPGA), or other similar elements or a combination of the above elements. The processor 100 is coupled to the storage medium 200 and the transceiver 300. The processor 100 can access and execute a plurality of modules stored in the storage medium 200 to implement functions of the automated model training device 10.

The storage medium 200 is, for example, any type of fixed or removable random access memory (RAM), read-only memory (ROM), flash memory, hard disk drive (HDD), solid state drive (SSD) or other similar elements or a combination of the above elements, and it is configured to store a plurality of modules or various applications that can be executed by the processor 100. In the embodiment, the storage medium 200 may store a plurality of modules including a preprocessing module 201, a machine learning module 202, and a training module 203, and functions thereof will be described later.

The transceiver 300 transmits and receives signals in a wireless or wired manner. The transceiver 300 may also execute operations such as low noise amplification, impedance matching, frequency mixing, up or down frequency conversion, filtering, amplification, and the like.

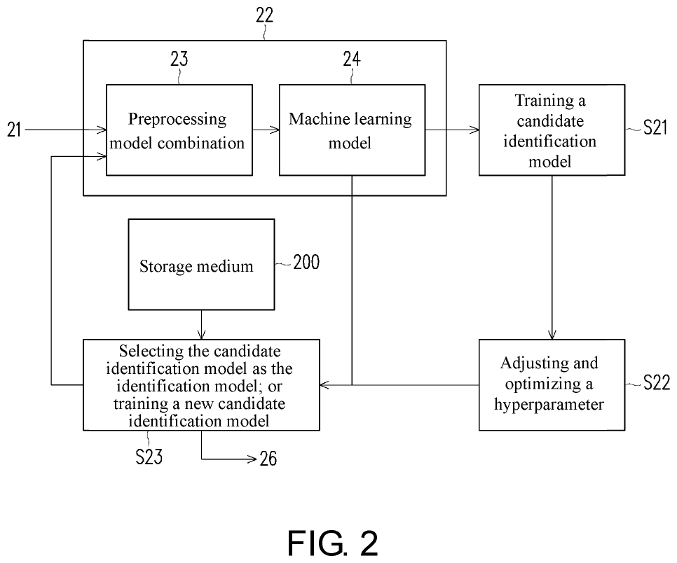

FIG. 2 is a schematic diagram of training an identification model 26 using the automated model training device 10 according to an embodiment of the disclosure. With reference to FIGS. 1 and 2, the automated model training device 10 may obtain spectral data 21 for training the identification model 26 with the transceiver 300 (from a spectrometer, for example). The training module 203 in the storage medium 200 may train the identification model 26 according to the spectral data 21.

Specifically, the preprocessing module 201 of the storage medium 200 may store a plurality of preprocessing models for preprocessing the spectral data 21, wherein the plurality of preprocessing models may be associated with, for example, a smooth program, a wavelet program, a baseline correction program, a differentiation program, a standardization program, or a Random Forest (RF) program, and the disclosure is not limited thereto.

In addition, the machine learning module 202 of the storage medium 200 may store a plurality of machine learning models for training an identification model for the spectral data 21. The plurality of machine learning models stored by the machine learning module 202 may include, for example, a regression model and a classification model, and the disclosure is not limited thereto.

The training module 203 may select one or a plurality of preprocessing models from the preprocessing module 201 and sort the one or the plurality of preprocessing models to generate a preprocessing model combination 23 including at least one preprocessing model. For example, the training module 203 may select a plurality of preprocessing models from the preprocessing module 201 to combine and form one aspect of the preprocessing model combination 23 as shown in Table 1. It can be seen from Table 1 that the aspect #1 sequentially including the smooth program, the wavelet program, the baseline correction program, the differentiation program, and the standardization program corresponds to the minimum mean square error (MSE); therefore, in the embodiment, the aspect #1 is an optimal aspect of the preprocessing model combination 23. In the disclosure, in other embodiments, one aspect may include a different number of programs, and the disclosure is not limited thereto.

TABLE 1

| | | First | Second | Third | Fourth | Fifth |
|---|---|---|---|---|---|---|
| | MSE | program | program | program | program | program |
| #1 | 2.120 | Smooth | Wavelet | Baseline | Differentiation | Standardization |
| | | | | Correction | | |
| #2 | 2.143 | Smooth | Wavelet | Differentiation | Baseline | Standardization |
| | | | | | Correction | |
| #3 | 2.171 | Wavelet | Smooth | Differentiation | Baseline | Standardization |
| | | | | | Correction | |
| #4 | 2.172 | Wavelet | Differentiation | Smooth | Baseline | Standardization |
| | | | | | Correction | |
| #5 | 2.183 | Wavelet | Differentiation | Baseline | Smooth | Standardization |
| | | | | Correction | | |

In addition, the training module 203 may further select a machine learning model 24 from the machine learning module 202. The training module 203 may combine the preprocessing model combination 23 and the machine learning model 24 into a pipeline 22. The pipeline 22 further includes information such as a hyperparameter (or a hyperparameter combination) corresponding to the preprocessing model combination 23 and a hyperparameter (or a hyperparameter combination) corresponding to the machine learning model 24. Specifically, the hyperparameter combination may be associated with data variables to be adjusted in the machine learning model 24 set by the user, including, for example, the number of layers of neural network, a loss function, the size of a convolution kernel, a learning rate, and the like.

After the composition of the pipeline 22 is determined, in step S21, the training module 203 may train a candidate identification model according to the spectral data 21. Specifically, the training module 203 may segment the spectral data 21 into a training set and a verification set. The training module 203 may use the training set to train the pipeline 22 to generate a candidate identification model corresponding to the pipeline 22. The loss function used in training the candidate identification model is associated with, for example, a mean square error (MSE) algorithm, but the disclosure is not limited thereto.

Then, in step S22, the training module 203 may use the verification set of the spectral data 21 to adjust and optimize a hyperparameter (or a hyperparameter set) of the candidate identification model corresponding to the pipeline 22. The training module 203 may determine an optimal hyperparameter (or an optimal hyperparameter set) for the candidate identification model according to algorithms such as a grid search algorithm, a permutation search algorithm, a random searching algorithm, a Bayesian optimization algorithm, a genetic algorithm, a reinforcement learning algorithm, or the like.

After the optimal hyperparameter is determined, in step S23, the training module 203 may determine the performance of the pipeline 22 according to the candidate identification model corresponding to the pipeline 22 and its optimal hyperparameter. After the performance of the pipeline 22 is obtained, the training module 203 may decide whether to select the candidate identification model corresponding to the pipeline 22 as the identification model 26 and output the identification model 26. For example, the training module 203 may decide to output the candidate identification model as the identification model 26 to be used by the user according to the performance of the candidate identification model being good (for example, the mean square error of the loss function of the candidate identification model is less than a threshold).

Alternatively, in step S23, the training module 203 may select to train a new candidate identification model, and select, from a plurality of candidate identification models trained by the training module 203, an optimal candidate identification model as the identification model 26. The training module 203 needs to generate a new pipeline 22 before training a new candidate identification model. For example, the training module 203 may generate a new preprocessing model combination 23 according to at least one of the plurality of preprocessing models in the preprocessing module 201, and generate a new machine learning model 24 according to one of the plurality of machine learning models in the machine learning module 202. Accordingly, the training module 203 may generate a new pipeline 22 with the new preprocessing model combination 23 and the new machine learning model 24. After the training module 203 generates a plurality of candidate identification models respectively corresponding to different pipelines, the training module 203 may select a specific candidate identification model as the identification model 26 in response to the performance of the specific candidate identification model being superior to other candidate identification models (for example, the loss function of the specific candidate identification model has the smallest value).

In an embodiment, the training module 203 may match the new preprocessing model combination 23 and the new machine learning model 24 according to algorithms, such as a grid search algorithm, a permutation search algorithm, a random searching algorithm, a Bayesian optimization algorithm, a genetic algorithm, a reinforcement learning algorithm, or the like, to generate the new pipeline 22 to train the identification model 26 according to the new pipeline 22. Since the composition of the pipeline 22 includes a plurality of different aspects, the training module 203 may quickly screen out a preferred composition of the pipeline 22 according to the algorithms described above, thereby reducing the training time of the identification model 26.

In another embodiment, the storage medium 200 may store a historical pipeline list corresponding to at least one pipeline, wherein the historical pipeline list records the compositions of the pipelines that the automated model training device 10 has used in the past. The training module 203 may select a historical pipeline from the historical pipeline list as a new pipeline 22 to train the identification model 26 according to the new pipeline 22. In other words, the historical pipeline list may help the training module 203 find the optimal pipeline 22 more quickly.

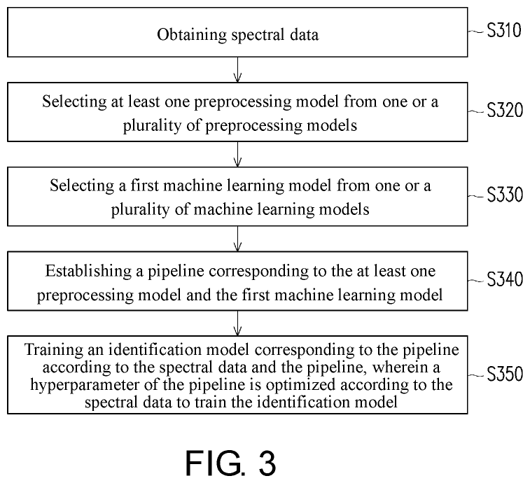

FIG. 3 is a flow chart of an automated model training method for a spectrometer according to an embodiment of the disclosure, wherein the automated model training method may be implemented by the automated model training device 10 (or the processor 100 of the automated model training device 10) as shown in FIG. 1. In step S310, spectral data are obtained. In step S320, at least one preprocessing model is selected from one or a plurality of preprocessing models. In step S330, a first machine learning model is selected from one or a plurality of machine learning models. In step S340, a pipeline corresponding to the at least one preprocessing model and the first machine learning model is established. In step S350, an identification model corresponding to the pipeline is trained according to the spectral data and the pipeline, wherein the training module optimizes the hyperparameter of the pipeline according to the spectral data to train the identification model.

Specifically, the pipeline corresponding to the identification model 26 represents the optimal combination for the spectral data 21, wherein the pipeline includes at least one preprocessing model combination and its hyperparameter (or its hyperparameter combination) and a machine learning model and its hyperparameter (or its hyperparameter combination). When the pipeline is used, the processor 100 may further train the pipeline with specific spectral data to obtain a specific identification model according to the specific spectral data.

In summary of the above, the disclosure can automatically select an optimal combination for specific spectral features from combinations of various preprocessing algorithms, machine learning algorithms, and hyperparameters to generate an identification model for detecting the specific spectral features. Experts will no longer need to establish corresponding identification models for different spectral features one by one.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An automated model training method for a spectrometer, wherein the automated model training method is executed by a processor and comprises:
obtaining spectral data;
selecting at least one preprocessing model from one or a plurality of preprocessing models;
selecting a first machine learning model from one or a plurality of machine learning models;
establishing a pipeline corresponding to the at least one preprocessing model and the first machine learning model; and
training an identification model corresponding to the pipeline according to the spectral data and the pipeline, wherein a hyperparameter of the pipeline is optimized according to the spectral data to train the identification model.

2. The automated model training method according to claim 1, further comprising selecting the at least one preprocessing model from the one or the plurality of preprocessing models and selecting the first machine learning model from the one or the plurality of machine learning models according to at least one algorithm, wherein the at least one algorithm comprises at least:
a grid search algorithm, a permutation search algorithm, a random searching algorithm, a Bayesian optimization algorithm, a genetic algorithm, and a reinforcement learning algorithm.

3. The automated model training method according to claim 1, wherein the one or the plurality of preprocessing models are associated with at least one of following programs:
a smooth program, a wavelet program, a baseline correction program, a differentiation program, a standardization program, and a Random Forest program.

4. The automated model training method according to claim 1, further comprising:
sorting the one or the plurality of preprocessing models to generate a preprocessing combination, wherein the pipeline comprises the preprocessing combination.

5. The automated model training method according to claim 1, further comprising:
storing a historical pipeline list corresponding to at least one pipeline; and
training the identification model according to the historical pipeline list.

6. The automated model training method according to claim 1, wherein the one or the plurality of machine learning models comprise a regression model and a classification model.

7. The automated model training method according to claim 1, wherein a loss function for training the identification model is associated with a mean square error algorithm.

8. An automated model training device for a spectrometer, the automated model training device comprising a transceiver, a processor, and a storage medium, wherein
the transceiver obtains spectral data,
the storage medium stores a plurality of modules, and
the processor is coupled to the transceiver and the storage medium, and accesses and executes the plurality of modules, wherein the plurality of modules comprise a preprocessing module, a machine learning module, and a training module, wherein
the preprocessing module stores one or a plurality of preprocessing models,
the machine learning module stores one or a plurality of machine learning models, and
the training module selects at least one preprocessing model from the one or the plurality of preprocessing models, selects a first machine learning model from the one or the plurality of machine learning models, establishes a pipeline corresponding to the at least one preprocessing model and the first machine learning model, and trains an identification model corresponding to the pipeline according to the spectral data and the pipeline, wherein the training module optimizes a hyperparameter of the pipeline according to the spectral data to train the identification model.

9. The automated model training device according to claim 8, wherein the training module selects the at least one preprocessing model from the one or the plurality of preprocessing models and selects the first machine learning model from the one or the plurality of machine learning models according to at least one algorithm, and the at least one algorithm comprises at least:
a grid search algorithm, a permutation search algorithm, a random searching algorithm, a Bayesian optimization algorithm, a genetic algorithm, and a reinforcement learning algorithm.

10. The automated model training device according to claim 8, wherein the one or the plurality of preprocessing models are associated with at least one of following programs:
a smooth program, a wavelet program, a baseline correction program, a differentiation program, a standardization program, and a Random Forest program.

11. The automated model training device according to claim 8, wherein the training module sorts the one or the plurality of preprocessing models to generate a preprocessing combination, wherein the pipeline comprises the preprocessing combination.

12. The automated model training device according to claim 8, wherein the storage medium further stores a historical pipeline list corresponding to at least one pipeline, and the training module trains the identification model according to the historical pipeline list.

13. The automated model training device according to claim 8, wherein the one or the plurality of machine learning models comprise a regression model and a classification model.

14. The automated model training device according to claim 8, wherein a loss function for training the identification model is associated with a mean square error algorithm.

15. A spectrometer comprising an automated model training device, the automated model training device comprising a transceiver, a processor, and a storage medium, wherein
the transceiver obtains spectral data,
the storage medium stores a plurality of modules, and
the processor is coupled to the transceiver and the storage medium, and accesses and executes the plurality of modules, wherein the plurality of modules comprise a preprocessing module, a machine learning module, and a training module, wherein
the preprocessing module stores one or a plurality of preprocessing models,
the machine learning module stores one or a plurality of machine learning models, and
the training module selects at least one preprocessing model from the one or the plurality of preprocessing models, selects a first machine learning model from the one or the plurality of machine learning models, establishes a pipeline corresponding to the at least one preprocessing model and the first machine learning model, and trains an identification model corresponding to the pipeline according to the spectral data and the pipeline, wherein the training module optimizes a hyperparameter of the pipeline according to the spectral data to train the identification model.

16. The spectrometer according to claim 15, wherein the one or the plurality of preprocessing models are associated with at least one of following programs:
a smooth program, a wavelet program, a baseline correction program, a differentiation program, a standardization program, and a Random Forest program.

17. The spectrometer according to claim 15, wherein the training module sorts the one or the plurality of preprocessing models to generate a preprocessing combination, wherein the pipeline comprises the preprocessing combination.

18. The spectrometer according to claim 15, wherein the storage medium further stores a historical pipeline list corresponding to at least one pipeline, and the training module trains the identification model according to the historical pipeline list.

19. The spectrometer according to claim 15, wherein the one or the plurality of machine learning models comprise a regression model and a classification model.

20. The spectrometer according to claim 15, wherein a loss function for training the identification model is associated with a mean square error algorithm.
